(19) United States
(12) Patent Application Publication
(10) Pub. No.: US 2011/0138577 A1
(43) Pub. Date: Jun. 16, 2011

(54) HINGE

(75) Inventor: JUNG-BIN CHANG, Tu-Cheng (TW)

(73) Assignee: HON HAI PRECISION INDUSTRY CO., LTD., Tu-Cheng (TW)

(21) Appl. No.: 12/644,014

(22) Filed: Dec. 22, 2009

(30) Foreign Application Priority Data
Dec. 11, 2009 (CN) 200910311253.X

(51) Int. Cl. E05D 5/12

(52) U.S. Cl. 16/380

(57) ABSTRACT

A hinge includes a shaft defining a positioning depression, a rotation bracket rotatably mounted to the shaft, and a positioning member. A first end of the positioning member is fixedly mounted to the rotation bracket, and a second end of the positioning member defines a protuberance engagable in the positioning depression.

### BACKGROUND

1. Technical Field

The present disclosure relates to a hinge.

2. Description of Related Art

A collapsible device, such as a notebook computer, or a clamshell mobile phone, generally includes a base, and a cover pivotably mounted to the base via a hinge. The hinge generally includes a shaft, a fixing bracket mounted to the shaft, and a rotation bracket rotatably mounted to the shaft. The fixing bracket is mounted to the base, and the rotation bracket is mounted to the cover, making the cover rotatable relative to the base. However, the hinge does not have a locking function and unwanted openings may occur.

### BRIEF DESCRIPTION OF THE DRAWINGS

FIG. 1 is an exploded, isometric view of an exemplary embodiment of a hinge.

FIG. 2 is an inverted view of FIG. 1.

FIG. 3 is an assembled, isometric view of the hinge of FIG. 2.

FIG. 4 is a cutaway view of the hinge of FIG. 3, taken along the line IV-VI.

### DETAILED DESCRIPTION

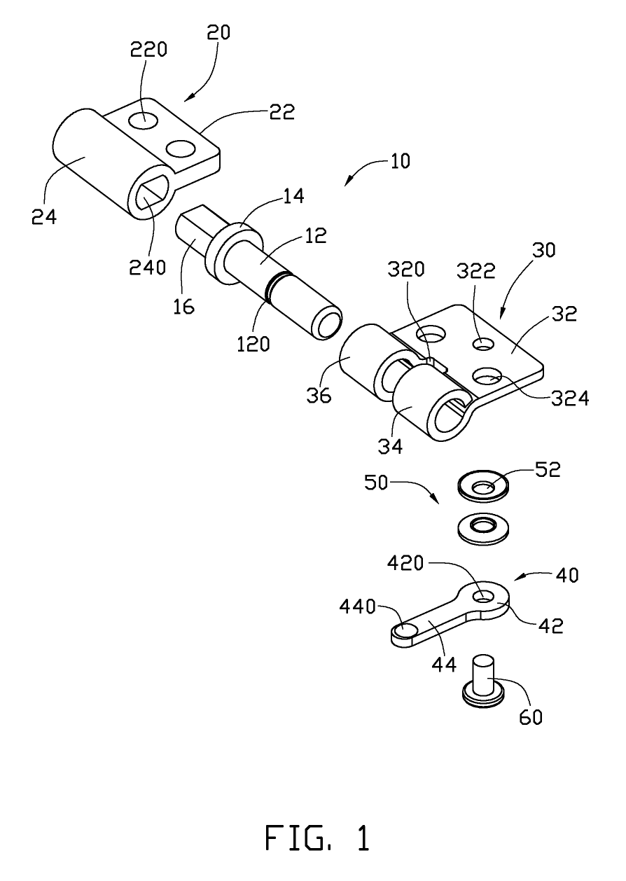

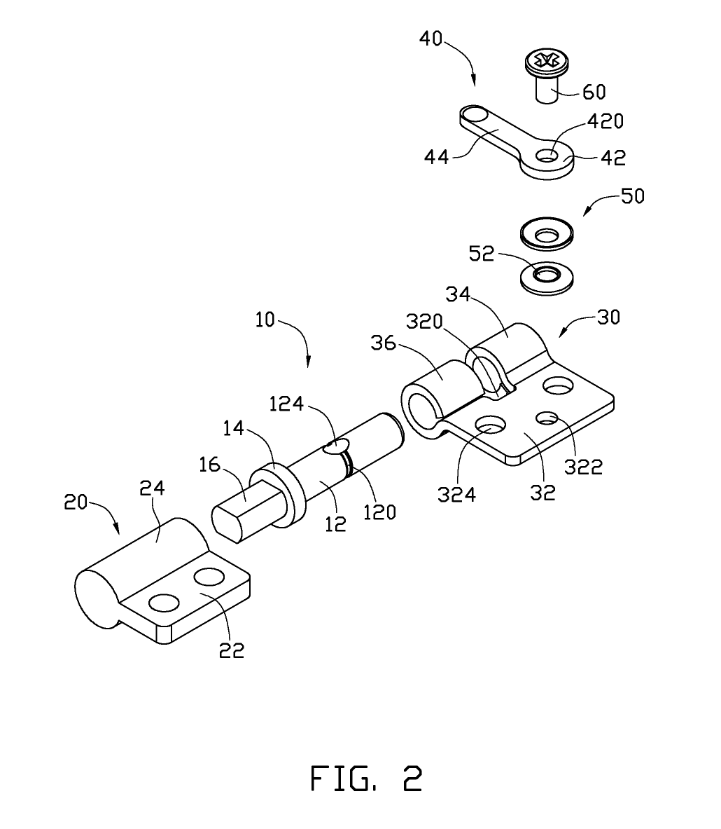

Referring to FIGS. 1 and 2, an exemplary embodiment of a hinge includes a shaft 10, a fixing bracket 20, a rotation bracket 30, a positioning member 40, a resilient assembly 50, and a fastener 60.

The shaft 10 includes a cylindrical rod 12. A first end of the fixing rod 12 forms a combination block 16 having a double-D shaped cross section. A circular protrusion 14 protrudes from a circumference of the fixing rod 12, adjacent to the combination block 16. A circumference of a center of the fixing rod 12 defines a sliding groove 120, and a conical positioning depression 124. Two opposite ends of the sliding groove 120 communicate with the positioning depression 124.

The fixing bracket 20 includes a fixing piece 22 defining two fixing holes 220 to fix the fixing bracket 20 to a base of a collapsible device, such as a notebook computer. A cylindrical combination portion 24 protrudes from a side of the fixing piece 22. The combination portion 24 axially defines a double-D shaped combination hole 240, to fixedly receive the combination block 16 of the shaft 10.

The rotation bracket 30 includes a fixing piece 32. A center of a side of the fixing piece 32 defines an incision 320. The side of the fixing piece 32 is bent and extends from two sides of the incision 320 in different directions, forming a first sleeve 34 and a second sleeve 36, through which the rod 12 of the shaft 10 rotatably extends. The first sleeve 34 is coaxial with the second sleeve 36, and an inner diameter of the first sleeve 34 is equal to an inner diameter of the second sleeve 36. The fixing piece 32 defines a fixing hole 322 to fix the position member 40 to the rotation bracket 30, and two through holes 324 to fix the rotation bracket 30 to a cover of the collapsible device. The fixing hole 322 of the rotation bracket 30 aligns with the incision 320.

The positioning member 40 includes a round fixing portion 42, and a positioning portion 44 radially extending from the fixing portion 42. The fixing portion 42 axially defines a though hole 420. An end of the positioning portion 44 spaced from the fixing portion 42 defines a protuberance 440, for engaging the positioning depression 124.

The resilient assembly 50 includes two stacked elastic elements, each defining a through hole 52 through which the fastener 60 can extend.

In one exemplary embodiment, the fastener 60 is a screw.

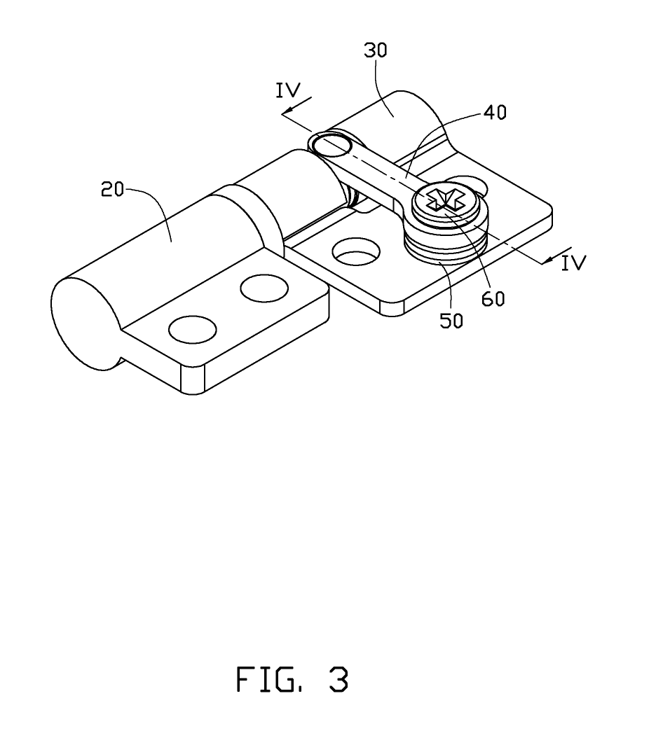

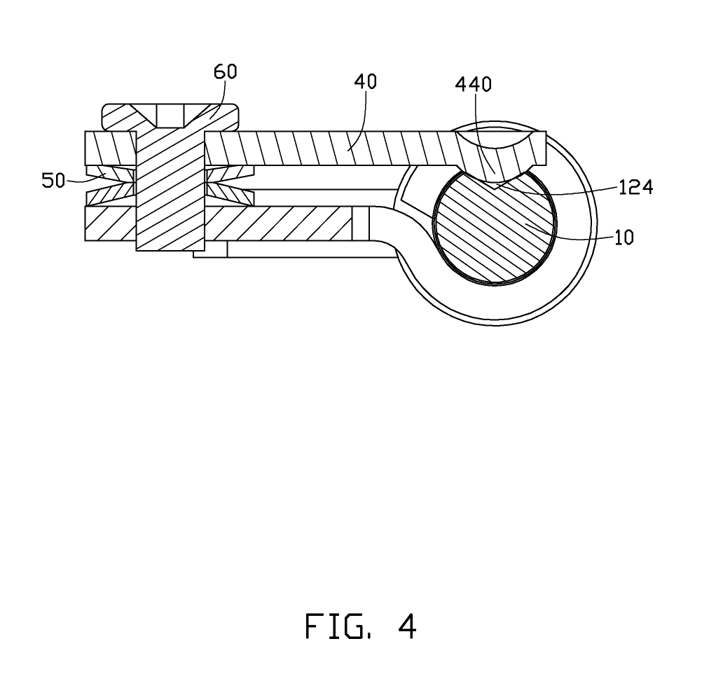

Referring to FIGS. 3 and 4, during assembly, the combination block 16 is received and fixed in the combination hole 240. The rod 12 extends through the second sleeve 36 and the first sleeve 34 in that order. The sliding groove 120 and the positioning depression 124 are located between the first and second sleeves 34 and 36. The fastener 60 extends through the through hole 420, and the through holes 52 of the elastic elements, to engage in the fixing hole 322 of the rotation bracket 30, thereby, the positioning member 40 is fixed to the rotation bracket 30. The positioning portion 44 extends from the fixing portion 42 to locate between the first and second sleeves 34 and 36. Therefore, the protuberance 440 is engagable in the positioning depression 124 or the sliding groove 120 of the shaft 10.

When closing the collapsible device, the rotation bracket 30 and the positioning member 40 synchronously rotate relative to the shaft 10, the protuberance 440 slides in the sliding groove 120. When the protuberance 440 engages in the positioning depression 124, the collapsible device becomes locked.

When the rotation bracket 30 and the positioning member 40 synchronously rotate relative to the shaft 10, the sliding groove 120 and the protuberance 440 can reduce friction between the positioning member 40 and the shaft 10. Obviously, in other implementations, if desired, the sliding groove 120 can be omitted and the protuberance 440 directly slides on a circumference of the rod 12.

In other implementation, the resilient assembly 50 can be omitted and elastic deformation of the positioning member 40 can make the protuberance 440 engage in the positioning depression 124.

The engaging force between the positioning depression 124 and the protuberance 440 can be changed by adjusting the numbers of the elastic elements of the resilient assembly 50 or adjusting the resisting power of the fastener 60 applying pressure on the resilient assembly 50.

It is to be understood, however, that even though numerous characteristics and advantages of the present disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

1. A hinge comprising:
a shaft defining a positioning depression;
a rotation bracket rotatably mounted to the shaft, wherein the rotation bracket comprises a fixing piece and an incision defined in a side of the fixing piece, a first sleeve and a second sleeve respectively extend from two sides of the incision in different directions, and the shaft rotatably extends therethrough; and
a positioning member detachably attached to the fixing piece and located between the first and second sleeves, the positioning member comprising a protuberance engagable in the positioning depression.

2. The hinge of claim 1, wherein the shaft comprises a cylindrical rod, the positioning depression is defined in a circumference of the rod, a sliding groove communicating with the positioning depression and in which the protuberance of the positioning member slides is also defined in the circumference of the rod.

3. The hinge of claim 2, wherein two opposite ends of the sliding groove communicate with the positioning depression.

4. The hinge of claim 1, wherein the fixing piece defines a fixing hole, the positioning member comprises a fixing portion defining a through hole, a fastener extends through the through hole and engages in the fixing hole, to fix the positioning member to the rotation bracket.

5. The hinge of claim 4, wherein a resilient assembly is located between the fixing piece of the rotation bracket and the fixing portion of the positioning member to increase engaging force between the positioning depression and the protuberance.

6. The hinge of claim 5, wherein the resilient assembly comprises a plurality of stacked elastic elements, and each of the plurality of elastic elements defines a through hole through which the fastener extends.

7. The hinge of claim 4, wherein a gap is defined between the first sleeve and the second sleeve corresponding to the incision, for the positioning member to extend therethrough.

8. The hinge of claim 7, wherein the positioning depression of the shaft is located between the first sleeve and the second sleeve.

9. The hinge of claim 7, wherein the protuberance of the positioning member is located between the first sleeve and the second sleeve, to engage with or disengage from the positioning depression of the shaft.

10. The hinge of claim 1, further comprising a fixing bracket, wherein the shaft comprises a cylindrical rod, one end of the cylindrical rod defines a combination block, and the fixing bracket comprises a combination portion, the combination portion defines a combination hole to engage the combination block.
